(19) United States
(12) Patent Application Publication
(10) Pub. No.: US 2018/0232793 A1
(43) Pub. Date: Aug. 16, 2018

(54) ENHANCED META-SEARCH ENGINE

(71) Applicant: Amadeus S.A.S., Biot (FR)

(72) Inventors: Simon Cognet, Antibes (FR); Julien Hugol, Biot (FR); Emmanuelle Geoffroy, Tourrettes Sur Loup (FR); Alexandra Sorrentino, Mougins (FR)

(21) Appl. No.: 15/433,145

(22) Filed: Feb. 15, 2017

(51) Int. Cl. G06Q 30/06; G06Q 30/04; G06Q 20/10; G06Q 20/34; G06Q 30/02

(52) U.S. Cl. CPC G06Q 30/0625; G06Q 30/04; G06Q 30/0222; G06Q 20/351; G06Q 20/102

(57) ABSTRACT

Systems, methods, and computer program products for enhancing a meta-search engine. In response to one of the results generated by the meta-search engine being selected for purchase via the meta-search engine, and to a fulfillment request including data associated with a first payment form and the selected result being received, the meta or the seller of the product included in the selected result is selected as a merchant. Furthermore, a settlement office is determined that is remote from the meta-search engine. Thereafter, while logged into the settlement office, an electronic record is generated that includes second payment data associated with the fulfillment request and one or more financial items. The first payment form is processed based on the merchant determination, and thereafter, a data feed including the one or more financial items is transmitted to the meta.

### TECHNICAL FIELD

The present invention generally relates to meta-search engines, and more particularly, to systems, methods, and computer program products for enhancing meta-search engines.

### BACKGROUND

Conventional meta-search engines utilize the search engines of other, remote systems to retrieve and display consolidated results via the Internet. For example, in the context of purchasing products via the Internet, when a user submits a product availability query to a conventional meta-search engine, the meta-search engine queries the search engines of several online systems that sell products to users based on the availability query. In response, the meta-search engine receives data including information about products available for sale from the online systems, and generates and displays a list of results to the user that includes the available products. Thereafter, if the user selects one of the products displayed by the meta-search engine for purchase, the user's system is redirected to the online system that sells the product to complete the purchase. In other words, the user leaves the system of the meta-search engine and is redirected to the online system, which collects payment from the user and completes the online transaction.

Conventional meta-search engines are generally limited to searching available products, and provide no mechanism by which a user may purchase a displayed product directly from the meta-search engine without being redirected to the remote system selling the product. Consequently, conventional meta-search engines are unable to accurately monitor and track conversation rates, as the user is redirected to another system to complete the purchase. Moreover, systems that process purchase transactions are typically configured with complex interfaces and programming for collecting payment and maintaining electronic records that facilitate the distribution of purchased products. Conventional meta-search engines lack such features, and modifying conventional meta-search engines to implement these features would result in significant increases to the technical complexity of the conventional meta-search engines. For example, such modifications would increase search response times by draining system resources, thereby creating a need for additional processing resources, and increase maintenance levels.

Accordingly, a need exists for improved systems, methods, and computer program products for enhancing meta-search engines with additional functionality in a manner that reduces the technical impact on existing systems.

### SUMMARY

In one exemplary embodiment, a system for enhancing a meta-search engine operated by a meta and configured to generate results in response to a search query, each of the results including a product offered for sale by a product seller system operated by a seller and having a domain name that differs from a domain name of the meta-search engine, includes one or more processors that are geographically remote from the meta-search engine, and a memory. The memory includes instructions that, upon execution by the one or more processors, cause the system to perform the following operations. In response to one of the results generated by the meta-search engine being selected for purchase by a user via the meta-search engine, and to a fulfillment request being received from the meta-search engine for the selected result, the fulfillment request including first payment data associated with a first payment form of the user and result data associated with the selected result, the system selects the meta or the seller operating the product seller system of the product included in the selected result as a merchant for the fulfillment request based on the fulfillment request. The system further determines a settlement office associated with the product seller system of the product included in the selected result based on the fulfillment request, where the settlement office is remote from the meta-search engine. Thereafter, the system logs into the settlement office, and while logged into the settlement office, generates an electronic record at the settlement office based on the result data and the merchant determination. The electronic record includes second payment data associated with the fulfillment request and one or more financial items that model a sale of the product included in the selected result. The system further processes the first payment form of the user based on the merchant determination, and after the first payment form is processed, generates a data feed including the one or more financial items, and transmits the data feed to the meta.

In some embodiments, the results generated by the meta-search engine may be associated with a unique offer ID, and may be stored in a database such that each result is linked to the offer ID associated with the result within the database. The result data may include the offer ID associated with the selected result, and in response to the fulfillment request being received, the instructions may cause the system to determine, from the database, the selected result based on the offer ID included in the result data.

Moreover, in response to the result being selected by the user for purchase, the user may be redirected to a payment collection page provided by the system that enables the user to enter the first payment form. In this case, the instructions upon execution may cause the system to, in response to receiving the first payment form of the user via the payment collection page, generate a payment token for the first payment form. The system may store the first payment form and the payment token in a database that is accessible by the system and not accessible by the meta-search engine such that the first payment form is linked to the payment token within the database, and transmit the payment token to the meta-search engine. To this end, the first payment data may include the payment token. Accordingly, in response to receiving the fulfillment request, the instructions may cause the system to determine, from the database, the first payment form based on the payment token included in the first payment data.

Furthermore, the instructions may cause the system to generate the electronic record at the settlement office based on the result data and the merchant determination by causing the system to, in response to selecting the meta as the merchant, generate a virtual credit card as the second payment data, and in response to determining the seller operating the product seller system of the product of the selected result as the merchant, insert the first payment form into the electronic record as the second payment data.

In addition, the system may include one or more memory devices storing databases accessible by the system and not accessible by the meta-search engine. Specifically, the system may include a first database and a second database. The first database may include the results generated by the meta-search engine, where each of the results are linked to a unique offer ID in the first database. To this end, the result data included in the fulfillment request may include the offer ID linked to the selected result within the first database. The second database may include second payment forms of users, where the second payment forms include the first payment form of the user that selected the result. Each of the second payment forms may be linked to a unique payment token within the second database, and the first payment data may include the payment token linked to the first payment form within the second database. In this case, the instructions upon execution may cause the system to, in response to the fulfillment request being received, store the payment token of the first payment data and the offer ID of the result data in a third database that is accessible by the system and is not accessible by the meta-search engine. The instructions may also cause the system to retrieve the selected result from the first database based on the offer ID of the result data, and retrieve the first payment form from the second database based on the payment token of the first payment data.

Moreover, in response to a system disruption when the fulfillment request is being processed, the instructions upon execution may cause the system to restart the processing of the fulfillment request by causing the system to retrieve, from the third database, the payment token and the offer ID stored in the third database. Thereafter, the system may retrieve the selected result from the first database based on the offer ID retrieved from the third database, and may retrieve the first payment form from the second database based on the payment token retrieved from the third database.

The system may also include one or more memory devices including a database that includes several entries, where each of the entries includes a seller identifier, a primary attribute, an alternative attribute, and a settlement office identifier. The instructions upon execution may cause the system to determine the settlement office associated with the product seller system of the product included in the selected result by causing the system to search the database for a first entry for which the seller identifier and the primary attribute match the fulfillment request. In response to the first entry not being found, the system may search the database for a second entry for which the seller identifier and the alternative attribute match the fulfillment request, and in response to the second entry being found, select the settlement office based on the settlement office identifier included in the second entry.

Additionally, the instructions upon execution may cause the system to log out of the settlement office and log into a meta-office associated with the meta-search engine. While logged into the meta-office, the system may retrieve the electronic record, add a financial item relating to a service fee charged by the meta-search engine to the electronic record, and set the financial item as confidential. Thereafter, the system may log out of the meta-office.

Furthermore, the system may include one or more memory devices comprising a database that includes a transaction fee for each of several payment form types. In this case, the instructions upon execution may cause the system to, in response to determining the meta as the merchant, generate, as the second payment data, a virtual credit card, and retrieve, from the database, a first transaction fee for processing the first payment form, and a second transaction fee for processing the virtual credit card. The system may then determine whether the first transaction fee is greater than the second transaction fee. In response to determining that the first transaction fee is greater than the second transaction fee, the system may generate an electronic voucher for a difference between the first transaction fee and the second transaction fee, and notify the user of the electronic voucher.

In another exemplary embodiment, a method for enhancing a meta-search engine operated by a meta and configured to generate results in response to a search query, where each of the results includes a product offered for sale by a product seller system operated by a seller and having a domain name that differs from a domain name of the meta-search engine, includes the following. In response to one of the results generated by the meta-search engine being selected for purchase by a user via the meta-search engine, and to a fulfillment request being received from the meta-search engine for the selected result at one or more processors, the fulfillment request including first payment data associated with a first payment form of the user and result data associated with the selected result, the method includes selecting, by the one or more processors, the meta or the seller operating the product seller system of the product included in the selected result as a merchant for the fulfillment request based on the fulfillment request, and determining, by the one or more processors, a settlement office associated with the product seller system of the product included in the selected result based on the fulfillment request. The settlement office is remote from the meta-search engine. Thereafter, the method includes logging, by the one or more processors, into the settlement office. While logged into the settlement office, the method further includes generating, by the one or more processors, an electronic record at the settlement office based on the result data and the merchant determination. The electronic record includes second payment data associated with the fulfillment request and one or more financial items that model a sale of the product included in the selected result. The method also includes processing, by the one or more processors, the first payment form of the user based on the merchant determination, and after the first payment form is processed, generating, by the one or more processors, a data feed including the one or more financial items, and transmitting, by the one or more processors, the data feed to the meta.

The method may further include performing any one or more of the operations and/or implementing any one or more of the features discussed above in reference to the exemplary system.

In a further exemplary embodiment, a computer program product for enhancing a meta-search engine operated by a meta and configured to generate results in response to a search query, each of the results including a product offered for sale by a product seller system operated by a seller and having a domain name that differs from a domain name of the meta-search engine, includes a non-transitory computer readable storage medium. Instructions are stored on the non-transitory computer readable storage medium that, upon execution by one or more processors that are geographically remote from the meta-search engine, cause the one or more processors to perform the following operations. In response to one of the results generated by the meta-search engine being selected for purchase by a user via the meta-search engine, and to a fulfillment request being received from the meta-search engine for the selected result, the fulfillment request including first payment data associated with a first payment form of the user and result data associated with the selected result, the one or more processors select the meta or the seller operating the product seller system of the product included in the selected result as a merchant for the fulfillment request based on the fulfillment request. The one or more processors further determine a settlement office associated with the product seller system of the product included in the selected result based on the fulfillment request, where the settlement office is remote from the meta-search engine. Thereafter, the one or more processors log into the settlement office, and while logged into the settlement office, generate an electronic record at the settlement office based on the result data and the merchant determination. The electronic record includes second payment data associated with the fulfillment request and one or more financial items that model a sale of the product included in the selected result. The one or more processors further process the first payment form of the user based on the merchant determination, and after the first payment form is processed, generate a data feed including the one or more financial items, and transmit the data feed to the meta.

The instructions upon execution may further cause the one or more processors to perform any one or more of the operations and/or implement any one or more of the features discussed above in reference to the exemplary system.

The above summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

Embodiments of the present invention will be understood and appreciated more fully from the following detailed description taken in conjunction with the drawings.

FIG. 1 is a schematic view of an exemplary operating environment that includes a plurality of systems for enhancing a meta-search engine.

FIG. 2 is a schematic view of an exemplary computer system in FIG. 1.

FIG. 3 is a schematic view of an exemplary processing architecture that may be implemented by one or more of the computer systems of FIG. 1.

FIG. 4 is a flowchart of an exemplary process for enhancing a meta-search engine that may be performed by the processing architecture of FIG. 3.

FIG. 5 is a flowchart of another exemplary process for enhancing a meta-search engine that may be performed by the processing architecture of FIG. 3.

FIG. 6 is a flowchart of a further exemplary process for enhancing a meta-search engine that may be performed by the processing architecture of FIG. 3.

### DETAILED DESCRIPTION

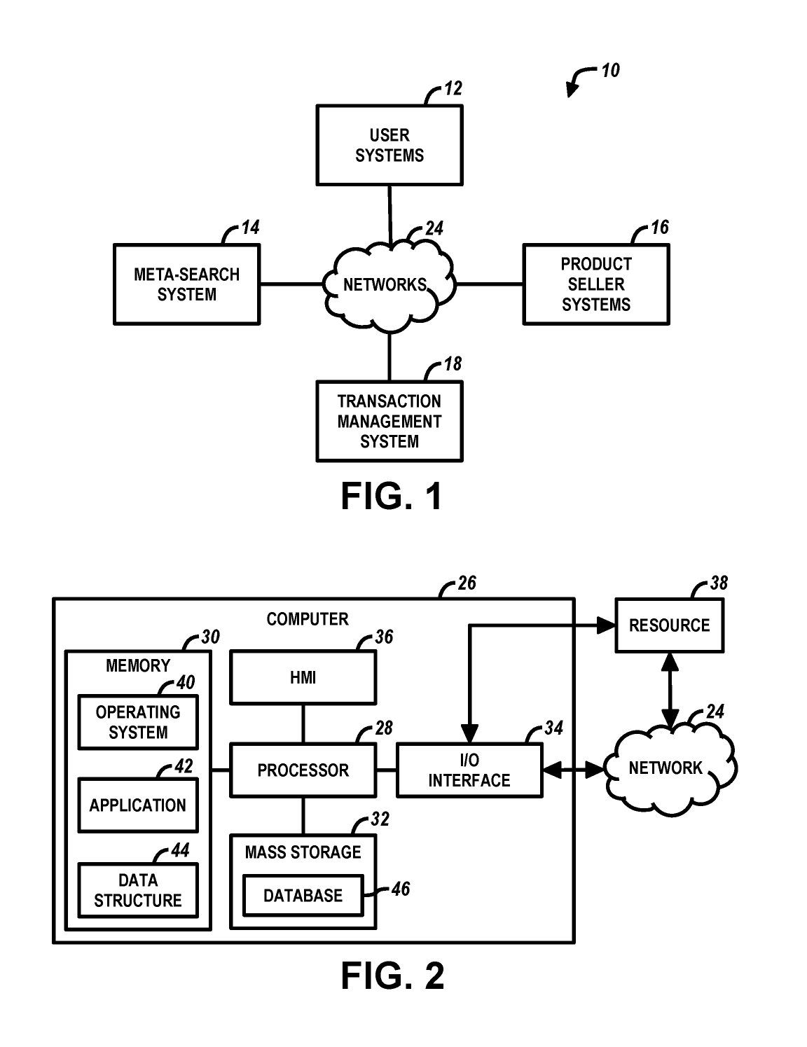

FIG. 1 illustrates an exemplary operating environment 10 that may include one or more user systems 12, a meta-search system 14, one or more product seller systems 16, and a transaction management system 18. Each of these systems may communicate with one another via one or more private and/or public networks 24, such as the Internet. One or more of these systems may be logically or physically (e.g., geographically or implemented by separate computer platforms) remote from one another. For example, the user systems 12, the transaction management system 18, and/or the product seller systems 16 may be logically or physically remote from the meta-search system 14. Moreover, one or more of these systems, such as the transaction management system 18 and/or one or more of the product seller systems 16, may each be implemented by a same one or more computer platforms. For example, two or more of the product seller systems 16 may share at least one computer platform.

The user systems 12 may include computer devices that enable users to access remote systems, such as the meta-search system 14 or the product seller systems 16, over the one or more networks 24. For example, a user system 12 may be a laptop, a desktop, a thin client terminal, a mobile device, or a tablet. Each user system 12 may include a web browser or one or more apps for connecting with the remote systems.

The product seller systems 16 may facilitate the sale of products over the Internet by various online sellers. Specifically, each online seller (referred to herein as “seller” for short) may be an online merchant (referred to herein as “merchant” for short), and may maintain one or more of the product seller systems 16. In general, a merchant may be considered as an entity or company that receives payment from a user in exchange for products sold to the user over the Internet. In other words, a merchant may sell products to users via the Internet by receiving and processing payment information from the user, either directly or via contracted third-parties, over the one or more networks 24 in exchange for the products.

The product seller systems 16 may enable a user to search and select for purchase products of one or more product providers (e.g., airlines, hotels, rental car companies, rail operators, etc.), and may collect and process payment data from the user for the selected products. Furthermore, the product seller systems 16 may track and manage an inventory of products offered by one or more product providers, and may facilitate the provision of sold products by generating and maintaining electronic records. Such electronic records may include purchase records, reservation records, receipts, contract documents, and/or tickets relating to sold products.

A given product seller system 16 may be operated by a particular product provider (i.e., the seller maintaining the product seller system 16 is a particular product provider), and likewise may be dedicated to managing and selling the products of the particular product provider. For example, the product provider may be an airline, and the products offered and managed by the given product seller system 16 may be travel products sold by the airline. Alternatively, a product seller system 16 may manage and sell products of a particular type, such as flight travel products, that are provided by multiple product providers. As a further example, a product seller system 16 may manage and sell products of multiple types and multiple product providers. For example, a single product seller system 16 may manage and sell flight travel products, hotel travel products, and rental car travel products via a single access point, such as a website.

In general, a user may connect to a product seller system 16 by instructing a user system 12 to access the product seller system 16, such as via a browser or app installed on the user system 12. Specifically, each product seller system 16 may include a website having a unique domain name and network address for accessing the product seller system 16. A user may therefore access a product seller system 16 by navigating a browser on the user system 12 to the unique domain name of the website hosted by the product seller system 16, or by launching an app installed on the user system 12 that is programmed to exchange information with the product seller system 16 via the domain name or the network address of the product seller system 16. Once connected to the product seller system 16, the user may interact with the website or app to search for and purchase products of the product seller system 16, such as via a product search engine hosted by the product seller system 16. Thereafter, the product seller system 16 may collect and process payment data from the user via the website or app in exchange for the selected products.

The meta-search system 14 may offer an alternative means through which a user may search for and purchase products offered by the product seller systems 16. In particular, the meta-search system 14 may be operated by a meta entity (herein referred to as “meta” for short), and may include a meta-search engine that, in response to receiving a search query from a user that includes one or more search criteria, queries the product seller systems 16 for available products based on the search criteria. The meta-search system 14 may then return a list of results that is responsive to the user's search query, the results including products that are offered for sale by the product seller systems 16 and that match the user's search criteria. In this way, the meta-search system 14 may provide a comprehensive list of products that are offered for sale by multiple, separate product seller systems 16.

A user may access the meta-search system 14 much in the same way that a user may access a product seller system 16. Specifically, the meta-search system 14 may include a website having a unique domain name and network address that differ from the domain names and network addresses of the product seller systems 16. A user may therefore access the meta-search system 14 by causing a web browser on a user system 12 to navigate to the domain name of the website of the meta-search system 14, or by opening an app installed on the user system 12 that is configured to exchange information with the meta-search system 14 via its network address or domain name. Thereafter, the user may interact with the web browser or app of the user system 12 to submit a search query to the meta-search engine of the meta-search system 14. The search query may include one or more search criteria that describe product features in which the user is interested.

In response to receiving the search query, the meta-search engine of the meta-search system 14 may query each of the product seller system 16 for product data based on the provided search criteria, such as by submitting a corresponding search query to a search engine hosted by each of the product seller systems 16 via their network addresses or domain names. The product data received from each product seller system 16 may include information about products available for sale from the product seller system 16 that match the search criteria, such as a description of each product, the cost of each product, the product provider of each product, and the remaining availability for each product. Alternatively, this data may have been cached by the meta-search system 14 in advance of receiving the user's search request. The meta-search engine of the meta-search system 14 may then generate a list of results based on the product data, which may then be displayed to the user via the browser or app of the user system 12. Each of the results may include one or more products that are available for sale from the product seller systems 16 and that match the user's search criteria. For example, a result may include a travel itinerary made up of one or more flights and/or a stay at a hotel available for purchase via a product seller system 16. In this way, the user is able to search and compare the products offered by multiple product seller systems 16 from a single access point, namely the meta-search system 14.

Conventional meta-search systems are limited to searching and displaying available products, and lack any mechanism by which a user may initiate a purchase directly from the meta-search systems. In other words, metas conventionally do not act as a merchant for products. Rather, when a user indicates a desire to purchase a product displayed by a conventional meta-search system, the meta-search system redirects the user to the product seller system responsible for tracking and selling the product. This redirection enables conventional meta-search systems to avoid the technical impact of having to implement mechanisms for collecting and processing payment data from users to collect payment for products, and for maintaining electronic records relating to the sale and distribution of products, which may be extremely complex for certain product types. For example, the provision of travel products typically involves a complex combination of reservation records, electronic tickets, and miscellaneous coupons for ancillary services, and involves industry-specific formats and interfaces.

However, such limited functionality also comes at a cost. For example, metas may receive revenue based on conversion rates (i.e., the number of users who actually purchase a product). Because conventional meta-search systems redirect users to remote product seller systems to complete product purchases that do not operate on behalf of the meta-search system, metas are often unable to reliably track conversion rates for their customers. Moreover, depending on the channel, redirection to another system in which to purchase a product is often unreliable (e.g., mobile channels involving apps), which may further adversely affect the meta's conversation rate. Additionally, when a user is redirected from a conventional meta-search system to another system, the user's payment options for the product are limited to those payment forms accepted by the system to which the user is redirected. As a result, the meta's conversion rate may further suffer because users are not able to utilize their preferred payment forms.

The transaction management system 18 enhances the meta-search system 14 by enabling the meta to act as a merchant while minimizing the technical impact to the meta-search system 14 and the product seller systems 16, and by improving user experience of the meta-search system 14. Specifically, a user may initiate a purchase of a result displayed by the meta-search system 14 directly therefrom. In response to one of the results displayed by the meta-search system 14 being selected for purchase, a fulfillment request relating to the selected result may be transmitted from the meta-search system 14 to the transaction management system 18. The fulfillment request may include the user's payment form, which may have been collected from the user by the meta-search system 14, and may include result data indicating the result selected by the user. Thereafter, the transaction management system 18 may determine whether the meta or the seller associated with the product seller system 16 of the selected result should be selected as the merchant for the transaction based on one or more rules. If the seller is selected as the merchant, then the transaction management system 18 may provide the user's payment form to the corresponding product seller system 16 for processing and settlement in exchange for the products of the selected result. Alternatively, if the meta is selected as the merchant, then the transaction management system 18 may proceed to process the user's payment form and settle on behalf of the meta, provide the user's payment form to the meta-search system 14 for processing and settlement, or provide the user's payment form to a third-party payment platform contracted to process and settle transactions on the meta's behalf.

Regardless of the merchant determination, the transaction management system 18 may cause the product seller system 16 corresponding to the selected result to generate and manage any electronic records that are necessary for the purchase. Moreover, the transaction management system 18 may generate and transmit a real-time data feed to the meta that includes information relating to the purchase, such as cost, payment information, purchased products, and so on, so as to enable the meta to reliably track a conversation rate.

Hence, the transaction management system 18 enables the meta to act as a merchant while minimizing the technical impacts on both the meta-search system 14 and the product seller systems 16. Specifically, the meta-search system 14 is not required to be modified with new functionality for generating and managing electronic records necessary for a purchase. Moreover, when the meta is selected as the merchant, the transaction management system 18 may be configured to generate a virtual credit card that is compatible with the interfaces and electronic records of the product seller system 16 corresponding to the selected result. In this way, the seller may later utilize the VCC to settle with the meta for the sold products, and does not need to make special technical accommodations to enable the meta to act as the merchant. Moreover, from a user perspective, all of the aforementioned processes may be obscured such that the user is not redirected to any product seller system 16, giving the impression that the entire transaction is processed at the meta-search system 14.

Referring to FIG. 2, the user systems 12, the meta-search system 14, the product seller systems 16, and the transaction management system 18 may be implemented on one or more computer devices or systems, such as exemplary computer system 26. The computer system 26 may include a processor 28, a memory 30, a mass storage memory device 32, an input/output (I/O) interface 34, and a Human Machine Interface (HMI) 36. The computer system 26 may also be operatively coupled to one or more external resources 38 via the network 24 or I/O interface 34. External resources may include, but are not limited to, servers, databases, mass storage devices, peripheral devices, cloud-based network services, or any other suitable computer resource that may be used by the computer system 26.

The processor 28 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 30. The memory 30 may include a single memory device or a plurality of memory devices including, but not limited, to read-only memory (ROM), random access memory (RAM), volatile memory, non-volatile memory, static random access memory (SRAM), dynamic random access memory (DRAM), flash memory, cache memory, or any other device capable of storing information. The mass storage memory device 32 may include data storage devices such as a hard drive, optical drive, tape drive, non-volatile solid state device, or any other device capable of storing information.

The processor 28 may operate under the control of an operating system 40 that resides in the memory 30. The operating system 40 may manage computer resources so that computer program code embodied as one or more computer software applications, such as an application 42 residing in memory 30, may have instructions executed by the processor 28. In an alternative embodiment, the processor 28 may execute the application 42 directly, in which case the operating system 40 may be omitted. One or more data structures 44 may also reside in memory 30, and may be used by the processor 28, operating system 40, or application 42 to store or manipulate data.

The I/O interface 34 may provide a machine interface that operatively couples the processor 28 to other devices and systems, such as the network 24 or the one or more external resources 38. The application 42 may thereby work cooperatively with the network 24 or the external resources 38 by communicating via the I/O interface 34 to provide the various features, functions, applications, processes, or modules comprising embodiments of the invention. The application 42 may also have program code that is executed by the one or more external resources 38, or otherwise rely on functions or signals provided by other system or network components external to the computer system 26. Indeed, given the nearly endless hardware and software configurations possible, persons having ordinary skill in the art will understand that embodiments of the invention may include applications that are located externally to the computer system 26, distributed among multiple computers or other external resources 38, or provided by computing resources (hardware and software) that are provided as a service over the network 24, such as a cloud computing service.

The HMI 36 may be operatively coupled to the processor 28 of computer system 26 in a known manner to allow a user to interact directly with the computer system 26. The HMI 36 may include video or alphanumeric displays, a touch screen, a speaker, and any other suitable audio and visual indicators capable of providing data to the user. The HMI 36 may also include input devices and controls such as an alphanumeric keyboard, a pointing device, keypads, pushbuttons, control knobs, microphones, etc., capable of accepting commands or input from the user and transmitting the entered input to the processor 28.

A database 46 may reside on the mass storage memory device 32, and may be used to collect and organize data used by the various systems and modules described herein. The database 46 may include data and supporting data structures that store and organize the data. In particular, the database 46 may be arranged with any database organization or structure including, but not limited to, a relational database, a hierarchical database, a network database, or combinations thereof. A database management system in the form of a computer software application executing as instructions on the processor 28 may be used to access the information or data stored in records of the database 46 in response to a query, where a query may be dynamically determined and executed by the operating system 40, other applications 42, or one or more modules.

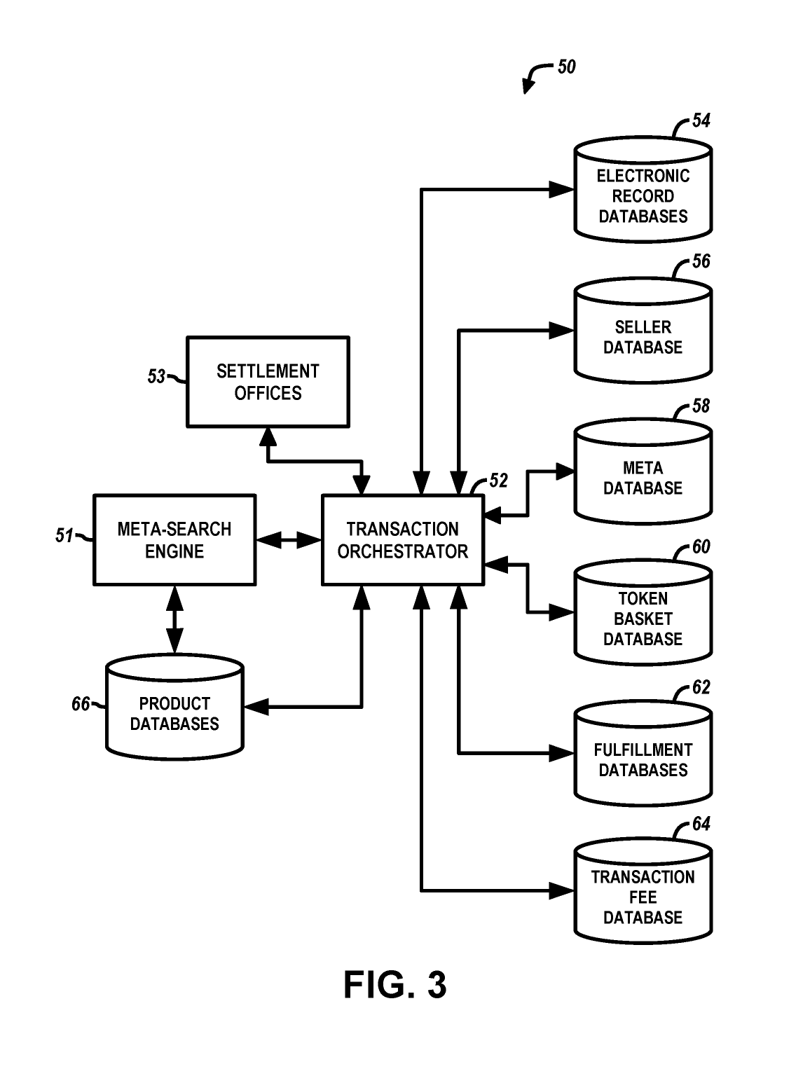

FIG. 3 illustrates an exemplary processing architecture 50 that may be implemented by one or more of the systems of operating environment 10. The processing architecture 50 may include a meta-search engine 51, a transaction orchestrator 52, several settlement offices 53, and several databases. In particular, the processing architecture 50 may include one or more electronic record databases 54, a seller database 56, a meta database 58, a token basket database 60, one or more fulfillment databases 62, a transaction fee database 64, and one or more product databases 66. In some embodiments, the meta-search system 14 may include the meta-search engine 51, the product seller systems 16 may include the settlement offices 53 and the electronic record databases 54, and the transaction management system 18 may include the transaction orchestrator 52 and one or more of the remaining databases. In general, the processing architecture 50 may enhance operation of the meta-search engine 51 by facilitating the processing of a fulfillment request generated when a user proceeds to purchase a product directly through the meta-search engine 51 (e.g., no redirection of the user system 12 to the product seller systems 16). In some embodiments, one or more of the databases may be combined. For example, the token basket database 50 and one or more of the fulfillment databases 62 may be part of a same database. The content of the databases and the operation of the processing architecture 50 is described in more detail below.

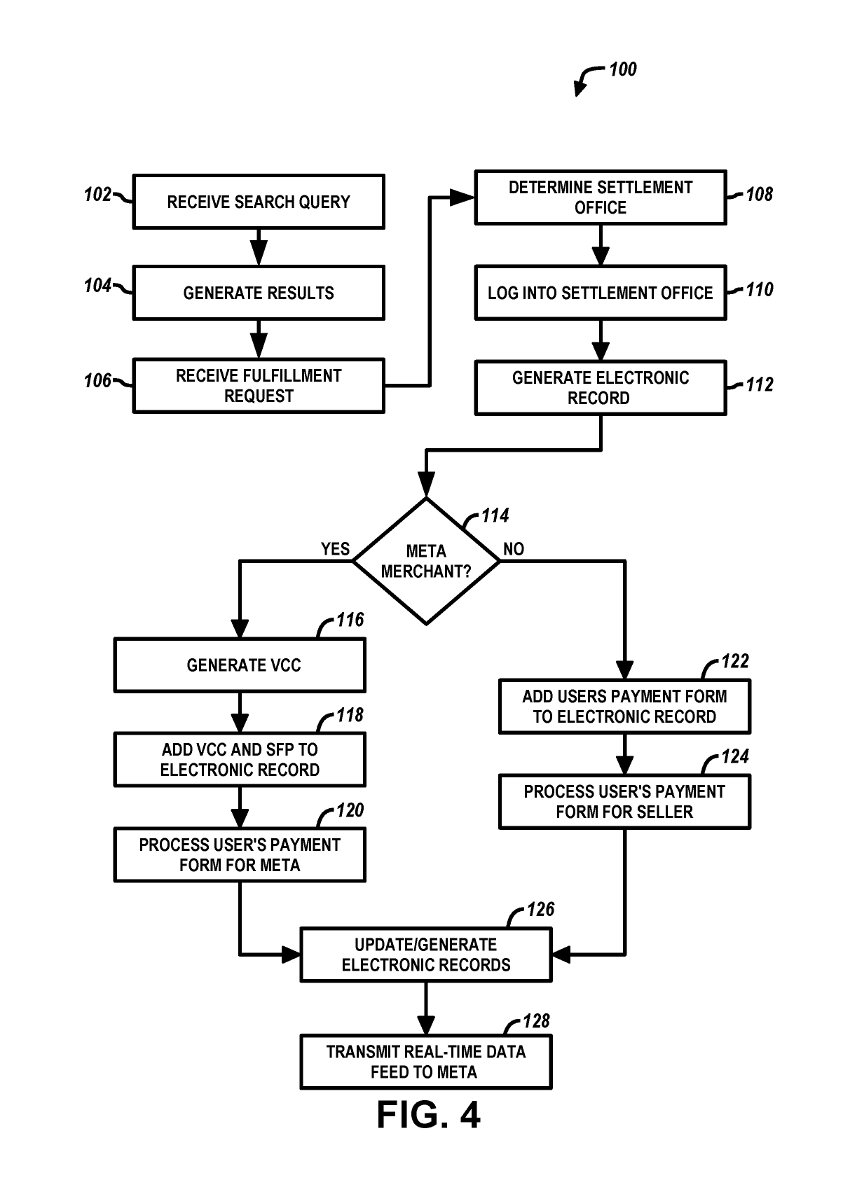

FIG. 4 illustrates an exemplary process 100 for enhancing the meta-search engine 51, such as via the transaction orchestrator 52, so as to enable online purchase transactions to be initiated directly from the meta-search engine 51. The process 100 may be performed by the processing architecture 50.

In block 102, a search query may be received at the meta-search engine 51. In particular, a user may activate an app on a user system 12 that is programmed to exchange content with the meta-search engine 51, or navigate a browser on a user system 12 to a website connected with the meta-search engine 51. Thereafter, the user may interact with the website or app to submit a search query to the meta-search engine 51. The search query may include a plurality of search criteria that describe product features in which the user is interested.

In block 104, in response to receiving the search request, the meta-search engine 51 may generate a plurality of results satisfying the search criteria. Each of the results may include one or more products offered for sale by one or more product seller systems 16, such that the results amount to a comprehensive list of products available for sale from several sellers. As previously discussed, each of the product seller systems 16 may have a unique domain name and network address that differ from those for the meta-search engine 51.

In particular, each product database 66 of the processing architecture 50 may be maintained by one of the product seller systems 16, and may include data indicative of the available products offered for sale by the product seller system 16. Accordingly, upon receiving the search request, the meta-search engine 51 may query the product databases 66 based on the search criteria, such as by transmitting a query to a search engine of product seller systems 16 via the product seller system's 16 unique domain name or Internet Address. In response to the queries, the meta-search engine 51 may receive product data from each of the product seller systems 16. The product data from each product seller system 16 may include information about available products offered for sale by the product seller system 16 that satisfy the user's search criteria. For example, the product data may include a description of the available products, the cost of the products, an identification of the particular product seller system 16 from which the product data was retrieved, and an identification the product providers for the products. The meta-search engine 51 may then generate the results based on the received product data, and display the results for the user's review. In some applications, each result may include a travel itinerary comprising multiple travel products.

In some embodiments, the product data utilized to generate the results may be cached by the meta-search engine 51 in advance of receiving the search query from the user. For example, the meta-search engine 51 may cache product data relating to popular search queries. Moreover, the transaction orchestrator 52 may maintain access to the product databases 66, such as via the search engines of the product seller systems 16, and/or maintain the cache of product data relating to popular search queries. In this case, upon receiving the meta-search engine 51, the meta-search engine 51 may submit a corresponding query to the transaction orchestrator 52, which may then retrieve and transmit to the meta-search engine 51 the product data matching the search criteria.

In block 106, in response to the user selecting one of the results generated by the meta-search engine 51 for purchase, a fulfillment request may be received from the meta-search engine 51 at the transaction orchestrator 52. The fulfillment request may include user data, such as the user's name and payment data associated with a payment form of the user. The fulfillment request may also include result data associated with the selected result, such as an identification of the one or more products included in the selected result, a price associated with the one or more products of the selected result, an identification of the seller and/or product seller system 16 from which the one or more products of the selected result were retrieved, and an identification of the product providers associated with the one or more products of the selected result.

In some embodiments, in response to the user selecting one of the results for purchase, the meta-search engine 51 may query the user for a payment form (e.g., credit card). In particular, the meta-search system 14 may cause the browser or app of the user system 12 to display a user interface with fields for entering a payment form. In this case, the payment data included in the fulfillment request may include the user's entered payment form.

In alternative embodiments, in response to the result being selected by the user for purchase, the user system 12 may be redirected to a payment collection page provided by the transaction orchestrator 52. The user may then proceed to interact with collection page to provide his or her payment form. In response to receiving the payment form of the user via the payment collection page, the transaction orchestrator 52 may generate a unique payment token for the payment form, and store the payment form and the payment token in a payment database. The payment database may be accessible by the transaction orchestrator 52 and not the meta-search engine 51. The payment form and the payment token for the user may be linked to one another in the payment database, which may be one of the fulfillment databases 62 of processing architecture 50. The payment database may also include other payment forms linked to unique payment tokens that have been previously generated for the same or other users. Thereafter, the transaction orchestrator 52 may transmit the payment token linked to the user's payment form to the meta-search engine 51 and/or meta-search system 14. The payment data of the fulfillment request sent from the meta-search engine 51 to the transaction orchestrator 52 may then include the payment token. In this case, upon receiving the fulfillment request, the transaction orchestrator 52 may retrieve the user's payment form from the payment database based on the payment token.

In some embodiments, if a payment token had been previously generated for the user by the transaction orchestrator 52 in relation to a previous transaction, then the user may submit his or her payment token when selecting a result for purchase, and bypass entering a new payment form.

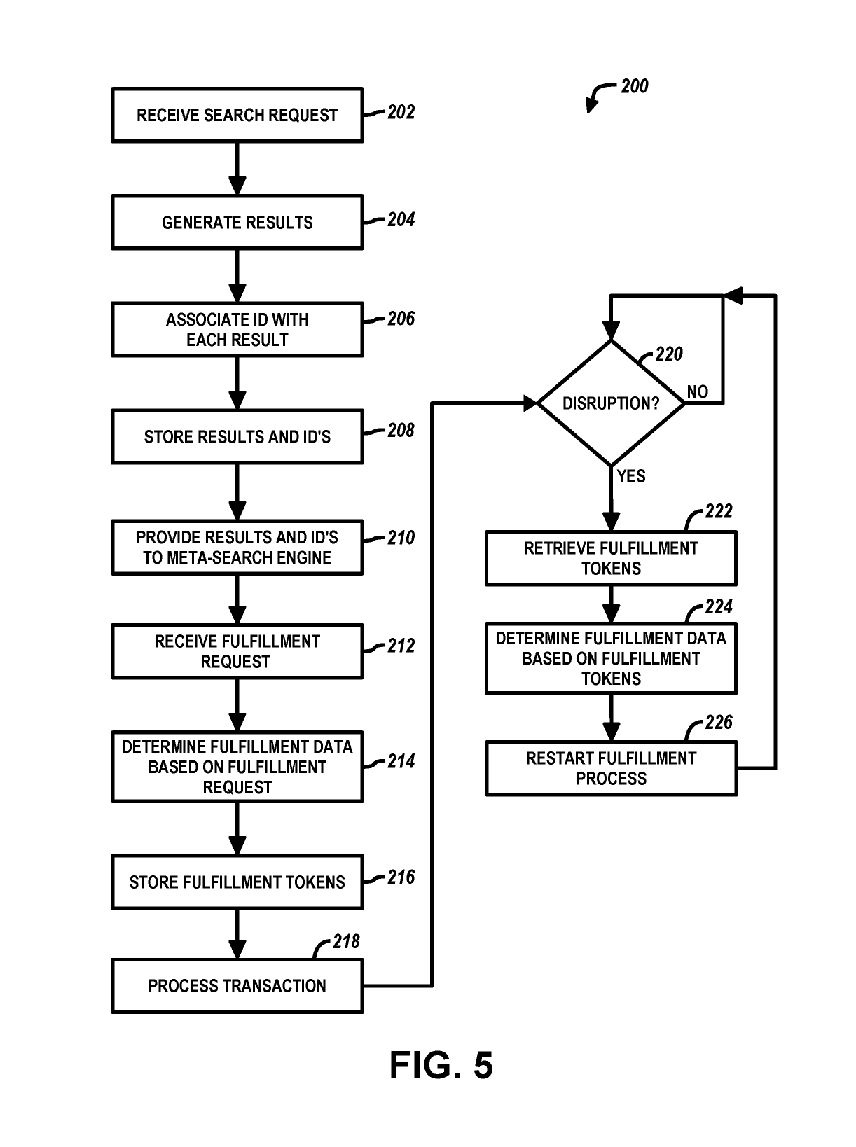

The aforementioned tokenization of the user's payment form may improve the security, reliability, and performance of the meta-search engine 51 and/or meta-search system 14. Specifically, this feature ensures that the user's actual payment form is passed between fewer systems, and that the user's actual payment form is kept separate and confidential from the meta-search engine 51 and the meta-search system 14. Correspondingly, this feature reduces the technical impact on the meta-search system 14, such as by avoiding the meta's need to implement payment collection pages and to develop systems complying with security standards associated with the sharing of user payment forms. Additionally, a payment token can be expressed using less data than an entire payment form, which improves the performance of the meta-search system 14 and the meta-search engine 51 by simplifying interfaces, lightening interface messages, and improving reliability relative to propagated network messages. The tokenization feature is described in further detail below in reference to FIG. 5.

In block 108, one of the settlement offices 53 that is associated the seller and/or product seller system 16 identified in the fulfillment request may be selected. In particular, each product seller system 16 may include one or more electronic settlement offices 53 in which to process purchase transactions. Each settlement office 53 may be enabled to generate electronic records and process payment forms to collect payment for a purchase transaction on behalf of the associated seller. In some embodiments, one or more of the settlement offices 53 of the product seller systems 16 may each be hosted by a same one or more computer platforms, and may utilize shared software modules for generating electronic records and processing payment forms. The determination of the specific settlement office 53 in which to process a transaction for a given seller may depend on several rules and the fulfillment request received from the meta-search engine 51. The settlement offices 53 may be logically and/or physically remote from the meta-search engine 51 and meta-search system 14.

In one embodiment, the determination of the specific settlement office 53 may depend on an identification of the seller, the country and currency associated with the user's payment form so as to avoid any currency exchange, and the language associated with the user, each of which may be included in or deduced (e.g., the tokenization feature) from the fulfillment request received from the meta-search engine 51. To this end, the seller database 56 may include one or more databases comprising several entries. Each entry may represent a rule that includes several general rule items, such as a seller identifier and a currency, one or more primary rule items, one or more alternative rule items, and/or an identifier for a settlement office 53. The one or more primary rule items may include one or more primary attributes, such as a primary country and a primary language, and the one or more alternative rule items may include one or more alternative attributes, such as an alternative country and an alternative language. Table A below shows two entries that may be stored in the seller database 56.

TABLE A

| | | | Alt. | Lan- | Alt. | Settlement |
|---|---|---|---|---|---|---|
| Seller | Currency | Country | Country | guage | Language | Office |
| AF | EUR | FR | BE | EN | FR | CDGAF0980 |
| LH | EUR | DE | | DE | | FRALH0980 |

To determine a settlement office 53, the transaction orchestrator 52 may search the seller database 56 for an entry having general rule items and primary rule items that match the data included in or deduced from the fulfillment request. For example, the transaction orchestrator 52 may search for an entry for which the seller identifier, currency, and/or one or more primary attributes match the fulfillment request. If such an entry is found, then the transaction orchestrator 52 may select the settlement office 53 identified in the entry. If no such entry is found, then the transaction orchestrator 52 may perform another search of the seller database 56 for one or more entries that match the data included in or deduced from the fulfillment request when one or more of the alternative rule items are also considered. For example, the transaction orchestrator 52 may search for one or more entries for which the seller identifier, the currency, one or more of the primary attributes, and/or one or more of the alternative attributes match the data included in or deduced from the fulfillment request.

In one embodiment, the transaction orchestrator 52 may select the settlement office 53 identified in the entry with the most matching rule items. If multiple matching entries are tied for having the most matching rule items, then the transaction orchestrator 52 may utilize weights assigned to the various rule items of each tied entry, and select the settlement office 53 identified in the entry with the highest sum weight. For example, the weight associated with a primary rule item may be greater than the weight associated with an alternative rule item. In this case, if one entry matches via two alternative rule items, and an additional entry equally matches via one alternative rule item and one primary rule item, then the additional entry has a greater sum weight and may be selected. As an alternative example, country may be associated with a greater weight than that which is associated with currency. Accordingly, if one entry matches via currency but not country, and an additional entry equally matches via country but not currency, then the additional entry may be selected as having a greater sum weight. The weights assigned to each rule item may be based on business rules or administrative assignments. In some embodiments, only some of the rule items may be subject to the weight assignments, such as currency, the primary attributes, and/or the secondary attributes. Moreover, matching one or more of the rules items, such as seller, may be a necessary precondition before an entry is to be considered for selection. If no matching entries are found after the subsequence search, then the transaction orchestrator 52 may reject the fulfillment request, and send a corresponding message to the meta-search engine 51 reporting the same.

In some embodiments, the meta may be able to influence the determination of a settlement office 53. In particular, the meta-search engine 51 may provide the transaction orchestrator 52 with an identification of a specific settlement office 53, such as in the fulfillment request transmitted to the transaction orchestrator 52. In this case, the transaction orchestrator 52 may bypass searching the seller database 56 and select the settlement office 53 identified in the fulfillment request. Alternatively, the meta or meta-search engine 51 may provide a list identifying several settlement offices 53 that may be selected by the transaction orchestrator 52. In this case, the transaction orchestrator 52 may proceed to search the seller database 56 as described above. However, as an additional check, the transaction orchestrator 52 may compare the settlement office 53 selected based on the search to those identified in the list. If the settlement office 53 selected by the transaction orchestrator 52 based on the search is not included in the list provided by the meta, then the transaction orchestrator 52 may reject the fulfillment request as described above.

In block 110, the determined settlement office 53 may be automatically logged into, such as by the transaction orchestrator 52. For example, the meta database 58 may include one or more databases that include login credentials for the meta relative to the settlement offices 53, including the determined settlement office 53. Accordingly, after the settlement office 53 is determined, the transaction orchestrator 52 may retrieve the meta's login credentials for the determined settlement office 53 from the meta database 58, and thereafter log into the determined settlement office 53 using the same.

In block 112, an electronic record may be generated, such as in one of the electronic record databases 54. In particular, while logged into the determined settlement office 53, the transaction orchestrator 52 may cause a purchase or reservation record to be generated and stored at the determined settlement office 53. In other words, a reservation record may be generated and stored in a reservation database included in the electronic record databases 54, and may be accessible via the settlement office 53, or by a user or system logged into the settlement office 53. When the transaction orchestrator 52 causes an event to occur at or in a determined settlement office 53, the event may be performed by the product seller system 16 including the determined settlement office 53 in conjunction with the transaction orchestrators 52 issuing a request to the product seller system 16 for the event. The content of the reservation record may be based on the data included in or deduced from the fulfillment request. For example, the reservation record may include an identification of a user (e.g., a passenger or purchaser), and an identification of the one or more products of the selected result. The transaction orchestrator 52 may then cause the one or more products to be priced using pricing data associated with the products of the selected result (e.g., fare data), and one or more financial items that model the sale of the one or more products may be added to the reservation record. In particular, the one or more financial items may include details relating to how the product was priced and sold. For example, each financial item may include a purchase price, discount and markup information, a payment status (e.g., paid or unpaid), and/or a sale status (e.g., not-issued, issued, or cancelled).

In block 114, a determination may be made of whether the meta or the seller of the one or more products included in the selected result should be the merchant for the online transaction. This determination may be based on the data included in or deduced from the fulfillment request. The merchant determination may be added to the reservation record generated for the purchase at the determined settlement office 53, such as in a financial item.

In response to determining that the meta should be the merchant (“YES” Branch of block 114), then in block 116, a virtual credit card (VCC) may automatically be generated. In particular, in order for the seller to sell the one or more products of the selected result to the user, the corresponding product seller system 16 may need to be provided with a payment form compatible with the product seller system 16. However, when the meta is acting as the merchant, it may not be desirable to provide that user's actual payment form to the seller for confidentially reasons. Accordingly, the transaction orchestrator 52 may call a VCC provider, such as a credit card provider or bank, to generate a VCC that is compatible with the product seller system 16 of the products of the selected result, and that is confidentially associated with the meta and the user's payment form by the transaction orchestrator 52.

In block 118, the transaction orchestrator 52 may cause payment data including the VCC to be inserted into the reservation record generated at the determined settlement office 53, such as in a Form of Payment (“FP”) element. Later, when the seller proceeds to settle the purchase, the seller may utilize the VCC to capture payment from the meta for the purchased products. In this way, the VCC eases settlement flows between the meta and the seller when the meta is the merchant, while reducing the technical impact on the product seller system 16.

In some embodiments, when a determination is made that the meta is to act as the merchant, the transaction orchestrator 52 may insert additional items into the reservation record that are accessible to the meta and are kept confidential from the seller. In particular, while logged into the determined settlement office 53, the transaction orchestrator 52 may cause a security element to be added to the reservation record that enables viewing and manipulation of the reservation record when logged into a meta-office associated with the meta. The meta-office may be hosted by the transaction orchestrator 52, may be implemented by a same one or more computer platforms as one or more of the settlement offices 53, and may share software modules with one or more of the settlement offices 53.

After the security element has been added to the reservation record, the transaction orchestrator 52 may log out of the determined settlement office 53 and log into the meta-office. While logged into the meta-office, the transaction orchestrator 52 may retrieve the reservation record and add a payment form element that models the user's actual payment form to the meta. Furthermore, the transaction orchestrator 52 may add another financial item to the reservation record that models a service fee charged by the meta for processing the transaction. The transaction orchestrator 52 may set each of these items as confidential in the reservation record so as to prevent the seller from retrieving or viewing this information via the determined settlement office 53. Thereafter, the transaction orchestrator 52 may log out of the meta-office and back into the determined settlement office 53 to perform the remaining parts of the process 100.

In block 120, the user's payment form may be processed for the meta, such as by the transaction orchestrator 52. In some embodiments, block 120 may include repricing the selected result, taking into account transaction fees associated processing the user's payment form when the meta is the merchant. In particular, the price shown to the user for each result displayed by the meta-search engine 51 may be based on the seller acting as the merchant. However, the transaction fees for the user's payment form may fluctuate depending on whether the meta or the seller is selected as the merchant, thereby causing a change in the price for the result selected by the user when the meta is selected as the merchant. Thus, if the re-calculated price is higher than what was originally presented to the user in relation to the selected result, the transaction orchestrator 52 may reject the fulfillment request, or may transmit a warning to the meta-search engine 51.

Assuming continued processing of the fulfillment request is warranted, either because the price of the selected result is not negatively impacted by the meta acting as the merchant, or because the meta-search engine 51, possibly at the user's direction, instructs the transaction orchestrator 52 to continue notwithstanding the warning of a higher price, the transaction orchestrator 52 may cause a payment platform associated with the meta to perform a fraud check on the user's payment form, and request an authorization from the bank associated with the user's payment form for the newly calculated price. The payment platform may be a third-party payment platform contracted by the meta and may be implemented by the transaction management system 18, or may be implemented by the meta-search system 14.

Alternatively, in response to determining that the seller of the one or more products included in the selected result should act as the merchant (“NO” branch of block 114), then in block 122, the transaction orchestrator 52 may cause payment data including the user's payment form to be added to the electronic record at the determined settlement office 53. In block 124, the user's payment form may be processed for the seller. Specifically, the transaction orchestrator 52 may cause a payment platform associated with the determined settlement office 53 and the corresponding product seller system 16 to conduct a fraud check on the user's payment form, and/or to authorize the user's provided payment form for the price of the purchase.

Thus, according to the process 100, the payment form of the user may be processed based on the merchant determination. Specifically, if the meta is selected as the merchant in block 114, then the payment form of the user may be processed based on the merchant determination by the transaction orchestrator 52 causing a payment platform associated with the meta to process the user's payment form (block 120). Alternatively, if the seller is selected as the merchant in block 114, then the payment form of the user may be processed based on the merchant determination by the transaction orchestrator 52 causing a payment platform associated with the product seller system 16 to process the user's payment information (as opposed to a VCC generated by the transaction orchestrator 52) (block 124).

In block 126, electronic records may be updated and/or generated at the determined settlement office 53. Specifically, the transaction orchestrator 52 may request contract issuance to confirm the sale, such as from the corresponding product seller system 16. In the case of air travel products, contract issuance may include ticket issuance. In response to the request, an electronic contract may be issued at the determined settlement office 53, which may be stored in a contract database that is included in the electronic record databases 54. In addition, the reservation record previously generated for the sale may be updated at the determined settlement office 53 to include a unique number associated with the generated electronic contract. In some embodiments, block 124 of the process 100 may be performed as part of block 126. In other words, the contract issuance request may also imply the request to process the user's payment information, which may then be performed at the determined settlement office 53 by the corresponding product seller system 16.

In block 128, after the user's payment form has been processed and the electronic records have been generated and/or updated, a real-time data feed may be generated and transmitted to the meta, such as by the transaction orchestrator 52. In particular, when the meta is the merchant, the feed may include the financial items and the user's payment details included in the reservation record. In this way, contemporaneously with the sale being completed, the meta may track an updated conversation rate. Relatedly, the data feed enables the meta to claim a referral fee from the seller with a justification, and perform a reconciliation between a received referral fee and the purchase. Moreover, the referral fee may be part of the settlement process between the seller and the meta, thereby enabling the provision of the referral fee to the meta in a reliable way.

In some embodiments, the meta-search system 14 may include several reporting offices maintained by the meta. In this case, the transaction orchestrator 52 may determine one of the reporting offices in which to send the real-time data feed based on several rules and rule items. In this way, each meta may consolidate reporting of various transactions to specific offices depending on the details of each transaction. More particularly, similar to the seller database 56, the meta database 58 may include one or more databases including several entries. Each of the entries may represent a rule that includes rule items and an identification of a reporting office. The rule items may include an identification of a meta, an identification of a particular meta-search engine 51 and/or meta-search system 14 of the meta from which the fulfillment request was sent (a meta may maintain multiple meta-search engines 51 and/or meta-search systems 14), and a currency, country, and region associated with the purchase. Table B below shows several entries that may be included in the meta database 58.

TABLE B

| Meta-Search | | | | | Reporting |
|---|---|---|---|---|---|
| Engine/System | Meta | Currency | Country | Region | Office |
| SuperSearch.us | META1 | USD | US | NORAM | NYCME2000 |
| MegaSearch.uk | META1 | GBP | UK | Europe | LONME2000 |
| MegaSearch.fr | META1 | EUR | FR | Europe | LONME2000 |
| AlwaysSearch.de | TOPMETA | EUR | DE | NECSE | FRATO2000 |

Hence, the transaction orchestrator 52 may search the meta database 58 for one or more entries that include rule items matching data included in or deduced from the fulfillment request. Thereafter, the transaction orchestrator 52 may select the reporting office identified in the entry having the most matched rule items in which to transmit the real-time data feed. If multiple entries are found that include a same number of matched items, then the transaction orchestrator 52 may utilize weights assigned to the rule items of each entry, and select the reporting office identified in the entry having the highest sum weight. For example, region may be associated with a weight that is greater than that which is associated with currency. In this case, if one entry matches via currency but not region, and an additional entry equally matches via region but not currency, then the additional entry may be selected as having the greatest sum weight. The weights assigned to each rule item may be based on business rules or administrative assignments. In some embodiments, only some of the rule items may be subject to the weight assignments, such as currency, country, and region. Moreover, matching one or more of the rules items, such as meta, may be a necessary precondition before an entry is to be considered for selection. If no entry is found, the transaction orchestrator 52 may default to sending the data feed to the meta-search engine 51 and/or meta-search system 14 from which the fulfillment request was received.

FIG. 5 illustrates a process 200 that may likewise be performed by the processing architecture 50 to enhance the meta-search engine 51. In particular, the process 200 improves the performance and integrity of the processing architecture 50 by utilizing data included in the fulfillment databases 62 and the token basket database 60. The fulfillment databases 62 may include a result database, a payment database, a voucher database, and a profile database. The content of each of these databases is described in additional detail below.

In block 202, a search request may be received from the user at the meta-search engine 51. In block 204, a plurality of results that satisfy the search request may be generated, such as by the meta-search engine 51 or the transaction orchestrator 52 based on the product data included in the product databases 66. These blocks may operate similarly to blocks 102 and 104 of the process 100 (FIG. 4).

In block 206, each of the results may be associated with a unique offer ID. In particular, the transaction orchestrator 52 or the meta-search engine 51 may generate a unique ID for each result. Thereafter, in block 208, the results and offer ID's may be stored in the result database such that each result is linked to its corresponding offer ID within the result database. For example, if the meta-search engine 51 generates the results and/or offer ID's, the meta-search engine 51 may transmit the results and/or offer ID's to the transaction orchestrator 52, which may then store the results and the offer ID's in the result database. The result database may be accessible by the transaction orchestrator 52, and not by the meta-search engine 51 and/or meta-search system 14. In some embodiments, the token basket database 60 may include or be combined with the result database in a single, larger database. In block 210, if the results and/or offer ID's were generated by the transaction orchestrator 52, the results and/or offer ID's may be transmitted to the meta-search engine 51. In any event, after the meta-search engine 51 has the results, the meta-search engine 51 may in turn display the results to the user for review.

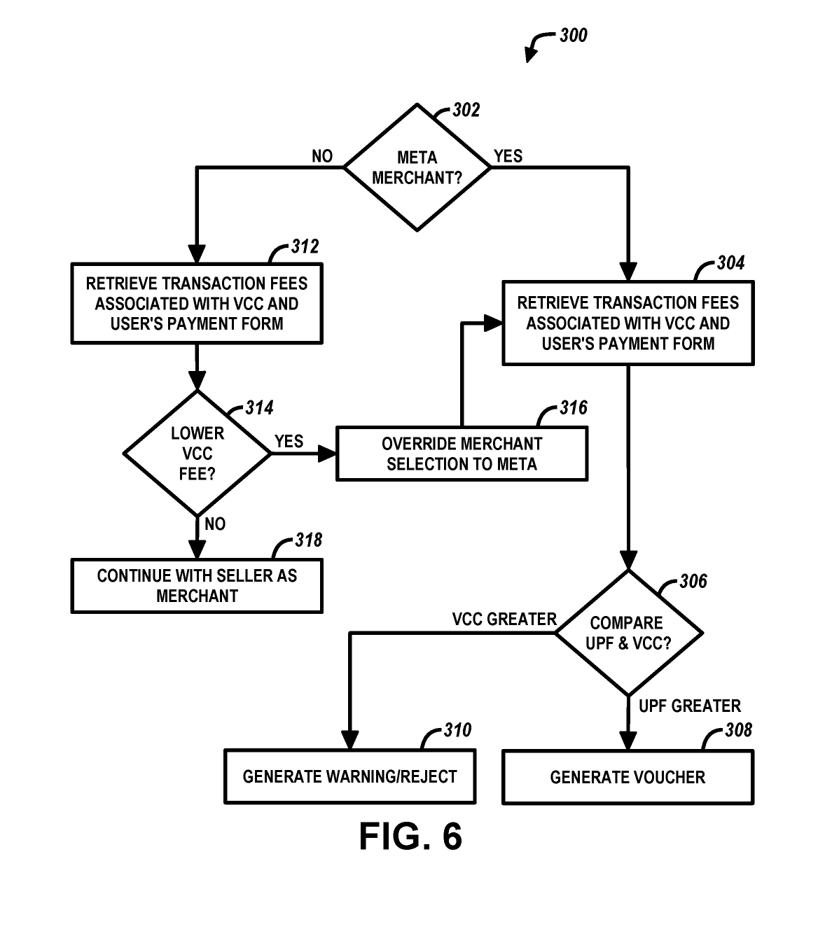

In block 212, in response to the user selecting one of the results for purchase, a fulfillment request may be received, such as at the transaction orchestrator 52. However rather than the fulfillment request including the user data and result data described above, the fulfillment request may include one or more tokens (also referred to herein as “ID's”). Specifically, the fulfillment request may include the offer ID corresponding to the selected result, such as in the result data of the fulfillment request. In addition or alternatively, the fulfillment request may include a profile ID that corresponds to a profile that is stored in the profile database, a voucher ID that corresponds to an electronic voucher that is stored in the voucher database that the user wishes to apply towards the price of the selected result, and/or a payment token that corresponds to a payment form of the user that is stored within the payment database. The profile ID, voucher ID, and/or payment token may be included in the user data of the fulfillment request. The user may have entered his or her payment form corresponding to the payment token for a previous transaction or in response to selecting the result to purchase, as described above. Similarly, the user may have created and stored a profile corresponding to the profile ID by interacting with the transaction orchestrator 52 as part of a previous transaction or in response to selecting the result to purchase. The electronic voucher corresponding to the voucher ID may have been created and stored in the voucher database in relation to a previous transaction, which is described in more detail in reference to FIG. 6.

By including the above tokens rather than the data to which those tokens correspond in the fulfillment request, the interfaces between the meta-search engine 51 and the transaction orchestrator 52 are lighter and more reliable. Specifically, because the tokens are represented by less data than the data to which the tokens correspond, less data needs to be exchanged between the meta-search engine 51 and the transaction orchestrator 52 when a user selects a result to purchase. Moreover, because less data is used to represent the fulfillment request, propagation becomes more reliable, as it becomes less likely that the fulfillment request will be altered via interference during the transmission. In addition, because the meta is not collecting and transmitting payment forms, certain compliance standards relating to the exchange of payment forms is avoided, which reduces the technical impact to the meta-search system 14. Similarly, the tokenization feature focuses traffic and processing to the system hosting the transaction orchestrator 52 rather than the meta-search engine 51, which improves performance of the meta-search engine 51 and the overall processing architecture 50. For example, the system hosting the transaction orchestrator 52 system may be configured so as to have access to additional processing resources and be better suited to handle increased traffic and processing, thereby further reducing the technical impact on the meta-search system 14.

In block 214, in response to the fulfillment request being received, fulfillment data may be determined based on the tokens included in the fulfillment request. In particular, the transaction orchestrator 52 may retrieve the user's selected result from the result database based on the offer ID included in the fulfillment request, the user's payment form from the payment database based on the payment token included in the fulfillment request, the electronic voucher for use towards the cost of the selected result from the voucher database based on the voucher ID included in the fulfillment request, and/or user information, such as a user's name, from the profile database based on the profile ID included in the fulfillment request.

In block 216, the tokens of the fulfillment request may be stored. In particular, the transaction orchestrator 52 may store the payment token, the offer ID, the voucher ID, and/or the profile ID included in the fulfillment request in the token basket database 60. The token basket database 60 may be accessible by the transaction orchestrator 52, and not the meta-search engine 51 or the meta-search system 14. Furthermore, the token basket database 60 may be stored on a nonvolatile memory device such that if the system hosting the database is restarted or disrupted, the data stored therein is retained.

Although storing the tokens of the fulfillment request (block 216) is illustrated as occurring after determining the fulfillment data based on the tokens in the fulfillment request (block 214), in other embodiments, the tokens of the fulfillment request may be stored prior to determining the fulfillment data. Storing the tokens prior to determining the fulfillment data may enhance reliability of the overall system, as the tokens will already be stored in case an error or system disruption occurs during the retrieval of the fulfillment data. Additional details on the handling of disruptions are provided below.

In block 218, the transaction initiated by the user from the meta-search engine 51 may continue to be processed. Specifically, the transaction orchestrator 52 may proceed to process the fulfillment request, such as by performing the operations set forth in the process 100 based on the retrieved fulfillment data (FIG. 4). Thereafter, in block 220, a determination may be made of whether processing of the fulfillment request has been disrupted. For example, a disruption may occur due to a system crash or power loss relative to any one of the systems of operating environment 10. After the disrupted system is back in normal operating condition, the transaction orchestrator 52 may determine that a disruption has occurred. In response to determining that there was a system disruption when the fulfillment request was being processed (“YES” branch of block 220), in block 222, the tokens included in the fulfillment request previously transmitted by the meta-search engine 51 may be retrieved from the token basket database 60. Thereafter, in block 224, the fulfillment data associated with the tokens may be retrieved, such as by the transaction orchestrator 52, from the fulfillment databases 62, as described above in connection with block 214. In block 226, processing of the transaction may then resume based on the fulfillment data. In this way, the transaction orchestrator 52 may restart the processing of the fulfillment request based on the retrieved fulfillment data after the disrupted system is back to a normal operating condition.

The process 200, and in particular the token basket database 60, provides an enhancement in the security and integrity of the systems implementing the processing architecture 50. In particular, the tokens stored in the token basket database 60 are quite small relative to the data that each is associated with. Accordingly, the process 200 enables storing the entire shopping basket of a user with very little data. Moreover, the storage and retrieval of such data may occur very quickly, thereby improving system response time. In addition, in the case of any system disruption, no data is lost and the process can be easily resumed or restarted.

FIG. 6 illustrates an exemplary process 300 that may be performed by the processing architecture 50 to further enhance the meta-search engine 51 and improve user experience. Specifically, as shown in the process 100 (FIG. 4), when the meta is selected as the merchant, a VCC may be generated and provided for the seller. In some situations, however, the transaction fee associated with processing the VCC generated for a given fulfillment request may be less than the transaction fee for processing of the user's payment form for the given fulfillment request. Accordingly, the transaction orchestrator 52 may be configured to generate a voucher for the user in this circumstance.

More particularly, in response to the meta being selected as the merchant for a given fulfillment request (“YES” branch of block 302), in block 304, a transaction fees for processing the user's payment form for the given fulfillment request by the meta may be retrieved, such as by the transaction orchestrator 52, and a transaction fee for processing the VCC generated for the fulfillment request by the seller (or the corresponding seller product system 16) may be retrieved, such as by the transaction orchestrator 52. Thereafter, in block 306, the retrieved transaction fees may be compared to determine which is greater. In particular, the transaction orchestrator 52 may determine whether the fee retrieved for the user's payment form is greater than or less than the transaction fee retrieved for the VCC.

In response to determining that the transaction fee retrieved for the user's payment form is greater than the transaction fee retrieved for the VCC (“UPF GREATER” branch of block 306), in block 308, an electronic voucher for the difference between the transaction fees may be generated and stored. In particular, the transaction orchestrator 52 may generate and store the electronic voucher in one of the fulfillment databases 62, namely a voucher database. The electronic voucher may include a voucher ID, and transaction orchestrator 52 may notify the user of the electronic voucher and provide the user with the voucher ID after the fulfillment request is processed, such as via sending a message to user system 12. The user may then enter the voucher ID the next time he or she utilizes the meta-search engine 51 to purchase a product.

Alternatively, in response to determining that the transaction fee for the VCC is greater than the transaction fee retrieved for the user's payment form (“VCC GREATER” branch of block 306), then in block 310, a rejection of the fulfillment request may be issued, or a warning may be generated and provided to the meta-search engine 51, such as by the transaction orchestrator 52. In the case of a warning, the process 100 (FIG. 4) may be halted (e.g., no further processing after block 116 or block 118) until the meta-search engine 51, possibly at the direction of the user, instructs the transaction orchestrator 52 to ignore the warning and continue.

Alternatively, in response to the meta not being selected as the merchant for a given fulfillment request (“NO” branch of block 302), then a determination may be made of whether this decision should be overridden to benefit the user. Specifically, in block 312, the transaction fee for processing the user's payment form in connection with the fulfillment request by the meta may be retrieved. In addition, one or more transaction fees for processing one or more potential VCC's in connection with the fulfillment request by the seller (or the corresponding product seller system 16) may be retrieved. In block 314, a determination may be made of whether at least one of the transaction fees for the potential VCC's is less than the transaction fee for the user's payment form. In other words, the transaction orchestrator 52 may compare each retrieved transaction fee for a VCC with the transaction fee for the user's payment form until a lower transaction fee for a VCC is found.

In response to finding a transaction fee for a VCC that is less than the transaction fee for the user's payment form (“YES” branch of block 314), then in block 316, the merchant decision may be overridden so that the meta is selected as the merchant for the fulfillment request. The process 300 may then proceed to blocks 304 and 306, which, as described above, may enable the user to benefit from the lower transaction fee via a voucher. Alternatively, if a lower transaction fee for processing a potential VCC is unable to be retrieved (“NO” branch of block 314), then in block 318, the fulfillment request may continue to be processed with the seller acting as the merchant.

In some embodiments, the transaction orchestrator 52 may obtain the aforementioned transaction fees by issuing a separate pricing request to the payment platforms associated with the meta-search engine 51 and the relevant product seller system 16 for each payment form or potential VCC of interest. However, processing each of these requests takes time and consequently would adversely affect system performance, especially given the large number of potential VCC's that may be generated for a fulfillment request. Hence, in order to improve system performance, the transaction orchestrator 52 may instead retrieve the relevant transaction fees from the transaction fee database 64.

To this end, the transaction fee database 64 may be pre-populated with several transaction fees for various sellers and/or payment form types. Specifically, as previously described, a transaction fee for a given payment form or VCC may fluctuate depending on whether the meta or the seller is processing the payment form or VCC, and also based on other data included in or deduced from of the fulfillment request. For example, a transaction fee for a given payment form or VCC may depend on type (e.g., credit card or debit card), brand, issuing country, currency, the products being purchased (e.g., for travel products, origin/destination and dates), point of sale, purchase date, and user type (e.g., passenger status). The transaction fees stored in the transaction fee database 64 may be indexed based on one or more of the above data items. In this way, rather than waiting for several pricing requests to be processed by one or more payment platforms, the transaction orchestrator 52 may simply query the transaction fee database 64 for the transaction fees of interest based on the data included in or deduced from the fulfillment request.

The transaction fee database 64 may be populated by updating the transaction fee database 64 with transaction fees each time a pricing request is processed by one of the payment platforms or one of the product seller system 16, and/or by refreshing the transaction fee database 64 on a batch basis based on such requests. In some embodiments, the data included in the transaction fee database 64 may be limited to those transaction fees related to popular fulfillment request content, such as popular sellers, products, routes, dates, etc.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

In certain alternative embodiments, the functions, acts, and/or operations specified in the flowcharts, sequence diagrams, and/or block diagrams may be re-ordered, processed serially, and/or processed concurrently consistent with embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for enhancing a meta-search engine operated by a meta and configured to generate a plurality of results in response to a search query, each of the results including a product offered for sale by a product seller system operated by a seller and having a domain name that differs from a domain name of the meta-search engine, the system comprising:
one or more processors that are geographically remote from the meta-search engine; and
a memory including instructions that, upon execution by the one or more processors, cause the system to:
in response to one of the results generated by the meta-search engine being selected for purchase by a user via the meta-search engine, and to a fulfillment request being received from the meta-search engine for the selected result, the fulfillment request including first payment data associated with a first payment form of the user and result data associated with the selected result:
select the meta or the seller operating the product seller system of the product included in the selected result as a merchant for the fulfillment request based on the fulfillment request;
determine a settlement office associated with the product seller system of the product included in the selected result based on the fulfillment request, the settlement office being remote from the meta-search engine;
log into the settlement office;
while logged into the settlement office, generate an electronic record at the settlement office based on the result data and the merchant determination, the electronic record including second payment data associated with the fulfillment request and one or more financial items that model a sale of the product included in the selected result;
process the first payment form of the user based on the merchant determination; and
after the first payment form is processed:
generate a data feed including the one or more financial items; and
transmit the data feed to the meta.

2. The system of claim 1 wherein each of the results generated by the meta-search engine is associated with a unique offer ID and is stored in a database such that each result is linked to the offer ID associated with the result within the database, the result data includes the offer ID associated with the selected result, and the instructions upon execution further cause the system to:
in response to the fulfillment request being received, determine, from the database, the selected result based on the offer ID included in the result data.

3. The system of claim 1 wherein in response to the result being selected by the user for purchase, the user is redirected to a payment collection page provided by the system that enables the user to enter the first payment form, and the instructions upon execution further cause the system to:
in response to receiving the first payment form of the user via the payment collection page:
generate a payment token for the first payment form;
store the first payment form and the payment token in a database that is accessible by the system and not accessible by the meta-search engine such that the first payment form is linked to the payment token within the database; and
transmit the payment token to the meta-search engine, wherein the first payment data includes the payment token.

4. The system of claim 3 wherein the instructions upon execution further cause the system to:
in response to receiving the fulfillment request, determine, from the database, the first payment form based on the payment token included in the first payment data.

5. The system of claim 1 wherein the instructions cause the system to generate the electronic record at the settlement office based on the result data and the merchant determination by causing the system to:
in response to selecting the meta as the merchant, generate a virtual credit card as the second payment data; and
in response to determining the seller operating the product seller system of the product of the selected result as the merchant, insert the first payment form into the electronic record as the second payment data.

6. The system of claim 1 further comprising:
one or more memory devices storing a plurality of databases accessible by the system and not accessible by the meta-search engine, the databases including:
a first database including the results generated by the meta-search engine, each of the results being linked to a unique offer ID in the first database, wherein the result data included in the fulfillment request includes the offer ID linked to the selected result within the first database; and
a second database including a plurality of second payment forms of a plurality of users, the second payment forms including the first payment form of the user that selected the result, wherein each of the second payment forms is linked to a unique payment token within the second database, and the first payment data includes the payment token linked to the first payment form within the second database,
wherein the instructions upon execution further cause the system to:
in response to the fulfillment request being received:
store the payment token of the first payment data and the offer ID of the result data in a third database that is accessible by the system and is not accessible by the meta-search engine;
retrieve the selected result from the first database based on the offer ID of the result data; and
retrieve the first payment form from the second database based on the payment token of the first payment data.

7. The system of claim 6 wherein the instructions upon execution further cause the system to:
in response to a system disruption when the fulfillment request is being processed, restart the processing of the fulfillment request by causing the system to:
retrieve, from the third database, the payment token and the offer ID stored in the third database;
retrieve the selected result from the first database based on the offer ID retrieved from the third database; and
retrieve the first payment form from the second database based on the payment token retrieved from the third database.

8. The system of claim 1 further comprising:
one or more memory devices including a database that comprises a plurality of entries, each of the entries including a seller identifier, a primary attribute, an alternative attribute, and a settlement office identifier,
wherein the instructions upon execution cause the system to determine the settlement office associated with the product seller system of the product included in the selected result by causing the system to:
search the database for a first entry for which the seller identifier and the primary attribute match the fulfillment request; and
in response to the first entry not being found:
search the database for a second entry for which the seller identifier and the alternative attribute match the fulfillment request; and
in response to the second entry being found, select the settlement office based on the settlement office identifier included in the second entry.

9. The system of claim 1 wherein the instructions upon execution further cause the system to:
log out of the settlement office and log into a meta-office associated with the meta-search engine;
while logged into the meta-office:
retrieve the electronic record;
add a financial item relating to a service fee charged by the meta-search engine to the electronic record; and
set the financial item as confidential; and
log out of the meta-office.

10. The system of claim 1 further comprising:
one or more memory devices comprising a database that includes a transaction fee for each of a plurality of payment form types,
wherein the instructions upon execution further cause the system to:
in response to determining the meta as the merchant:
generate, as the second payment data, a virtual credit card;
retrieve, from the database, a first transaction fee for processing the first payment form, and a second transaction fee for processing the virtual credit card;
determine whether the first transaction fee is greater than the second transaction fee; and
in response to determining that the first transaction fee is greater than the second transaction fee:
generate an electronic voucher for a difference between the first transaction fee and the second transaction fee; and
notify the user of the electronic voucher.

11. A method for enhancing a meta-search engine operated by a meta and configured to generate a plurality of results in response to a search query, each of the results including a product offered for sale by a product seller system operated by a seller and having a domain name that differs from a domain name of the meta-search engine, the method comprising:
in response to one of the results generated by the meta-search engine being selected for purchase by a user via the meta-search engine, and to a fulfillment request being received from the meta-search engine for the selected result at one or more processors, the fulfillment request including first payment data associated with a first payment form of the user and result data associated with the selected result:
selecting, by the one or more processors, the meta or the seller operating the product seller system of the product included in the selected result as a merchant for the fulfillment request based on the fulfillment request;
determining, by the one or more processors, a settlement office associated with the product seller system of the product included in the selected result based on the fulfillment request, the settlement office being remote from the meta-search engine;
logging, by the one or more processors, into the settlement office;
while logged into the settlement office, generating, by the one or more processors, an electronic record at the settlement office based on the result data and the merchant determination, the electronic record including second payment data associated with the fulfillment request and one or more financial items that model a sale of the product included in the selected result;
processing, by the one or more processors, the first payment form of the user based on the merchant determination; and
after the first payment form is processed:
generating, by the one or more processors, a data feed including the one or more financial items; and
transmitting, by the one or more processors, the data feed to the meta.

12. The method of claim 11 wherein each of the results generated by the meta-search engine is associated with a unique offer ID and is stored in a database such that each result is linked to the offer ID associated with the result within the database, the result data includes the offer ID associated with the selected result, and further comprising:
in response to the fulfillment request being received, determining, from the database, the selected result based on the offer ID included in the result data.

13. The method of claim 11 wherein in response to the result being selected by the user for purchase, the user is redirected to a payment collection page separate from the meta-search engine that enables the user to enter the first payment form, and further comprising:
in response to receiving the first payment form of the user via the payment collection page:
generating a payment token for the first payment form;
storing the first payment form and the payment token in a database that is not accessible by the meta-search engine such that the first payment form is linked to the payment token within the database; and
transmitting the payment token to the meta-search engine, wherein the first payment data includes the payment token.

14. The method of claim 13 further comprising:
in response to receiving the fulfillment request, determining, from the database, the first payment form based on the payment token included in the first payment data.

15. The method of claim 11 wherein generating the electronic record at the settlement office based on the result data and the merchant determination comprises:
in response to selecting the meta as the merchant, generating a virtual credit card as the second payment data; and
in response to determining the seller operating the product seller system of the product of the selected result as the merchant, inserting the first payment form into the electronic record as the second payment data.

16. The method of claim 11 further comprising:
storing, on one or more memory devices, a plurality of databases not accessible by the meta-search engine, the databases including:
a first database including the results generated by the meta-search engine, each of the results being linked to a unique offer ID in the first database, wherein the result data included in the fulfillment request includes the offer ID linked to the selected result within the first database; and
a second database including a plurality of second payment forms of a plurality of users, the second payment forms including the first payment form of the user that selected the result, wherein each of the second payment forms is linked to a unique payment token within the second database, and the first payment data includes the payment token linked to the first payment form within the second database,
wherein the method further comprises:
in response to the fulfillment request being received:
storing the payment token of the first payment data and the offer ID of the result data in a third database that is not accessible by the meta-search engine;
retrieving the selected result from the first database based on the offer ID of the result data; and
retrieving the first payment form from the second database based on the payment token of the first payment data.

17. The method of claim 16 further comprising:
in response to a system disruption when the fulfillment request is being processed, restart the processing of the fulfillment request by:
retrieving, from the third database, the payment token and the offer ID stored in the third database;
retrieving the selected result from the first database based on the offer ID retrieved from the third database; and
retrieving the first payment form from the second database based on the payment token retrieved from the third database.

18. The method of claim 11 further comprising:
storing, on one or more memory devices, a database that comprises a plurality of entries, each of the entries including a seller identifier, a primary attribute, an alternative attribute, and a settlement office identifier,
wherein determining the settlement office associated with the product seller system of the product included in the selected result comprises:
searching the database for a first entry for which the seller identifier and the primary attribute match the fulfillment request; and
in response to the first entry not being found:
searching the database for a second entry for which the seller identifier and the alternative attribute match the fulfillment request; and
in response to the second entry being found, selecting the settlement office based on the settlement office identifier included in the second entry.

19. The method of claim 11 further comprising:
logging out of the settlement office and logging into a meta-office associated with the meta-search engine;
while logged into the meta-office:
retrieving the electronic record;
adding a financial item relating to a service fee charged by the meta-search engine to the electronic record; and
setting the financial item as confidential; and
logging out of the meta-office.

20. A computer program product for enhancing a meta-search engine operated by a meta and configured to generate a plurality of results in response to a search query, each of the results including a product offered for sale by a product seller system operated by a seller and having a domain name that differs from a domain name of the meta-search engine, the computer program product comprising:
a non-transitory computer readable storage medium; and
instructions stored on the non-transitory computer readable storage medium that, upon execution by one or more processors that are geographically remote from the meta-search engine, causes the one or more processors to:
in response to one of the results generated by the meta-search engine being selected for purchase by a user via the meta-search engine, and to a fulfillment request being received from the meta-search engine for the selected result, the fulfillment request including first payment data associated with a first payment form of the user and result data associated with the selected result:
select the meta or the seller operating the product seller system of the product included in the selected result as a merchant for the fulfillment request based on the fulfillment request;
determine a settlement office associated with the product seller system of the product included in the selected result based on the fulfillment request, the settlement office being remote from the meta-search engine;
log into the settlement office;
while logged into the settlement office, generate an electronic record at the settlement office based on the result data and the merchant determination, the electronic record including second payment data associated with the fulfillment request and one or more financial items that model a sale of the product included in the selected result;
process the first payment form of the user based on the merchant determination; and
after the first payment form is processed:
generate a data feed including the one or more financial items; and
transmit the data feed to the meta.
